(19) United States
(12) Patent Application Publication
(10) Pub. No.: US 2002/0133585 A1
(43) Pub. Date: Sep. 19, 2002

(54) Computer program for recording and selective playback of a communication involving the hypertext transfer protocol

(76) Inventor: Douglas R. Deming, Kihei, HI (US)

Correspondence Address: Michael I. Kroll, 171 Stillwell Lane, Syosset, NY, 11791, US

(21) Appl. No.: 09/805,235

(22) Filed: Mar. 13, 2001

(51) Int. Cl. G06F 9/46; G06F 15/173

(52) U.S. Cl. 709/224; 709/328

(57) ABSTRACT

The present invention is a software program for capturing HTTP commands between a client and a remote server application for the purpose of creating an executable recording of HTTP commands as an automated login to the aforementioned remote server application.

The HTTP-API (hypertext transfer protocol application program interface) provides client side users with the ability to use the computer resources of a remote server computer to effect transaction processing and/or the transfer of information from one computer to another without having the absolute need for a web browser, plugins or software languages contained within the server system.

### BACKGROUND OF THE INVENTION

1. Field of the Invention

The present invention relates generally to communications software and, more specifically, to a hypertext transfer protocol application program interface (HTTP-API) method whereby a user of a first computer system can perform predetermined functions on a second computer system by exchanging commands using Hypertext Transfer Protocol (HTTP).

2. Description of the Prior Art

There are other computer software programs designed for Internet interfacing. Typical of these is U.S. Pat. No. 5,754,772 issued to Leaf on May 19, 1998.

Another patent was issued to Lewine on Jul. 21, 1998 as U.S. Pat. No. 5,784,565. Yet another U.S. Pat. No. 5,901,286 was issued to Danknick et al. on May 4, 1999 and still yet another was issued on May 18, 1999 to Wagner as U.S. Pat. No. 5,905,908.

Another patent was issued to Grate et al. on Sep. 21, 1999 as U.S. Pat. No. 5,956,483. Yet another U.S. Pat. No. 6,112,235 was issued to Spofford on Aug. 29, 2000. Another was issued to del Val on Oct. 3, 2000 as U.S. Pat. No. 6,128,653 and another was issued on Oct. 24, 2000 to Nichols et al. as U.S. Pat. No. 6,138,150 and still yet another was issued to Swales on Nov. 21, 2000 as U.S. Pat. No. 6,151,625..

U.S. Pat. No. 5,754,772

Inventor: Shawn T. Leaf

Issued: May 19, 1998

A system which makes prior art On-Line Transaction Processing (OLTP) systems and their associated databases accessible using HyperText Transport Protocol (HTTP) interfaces. The response time for an on-line user seeking HTTP access to the transaction processing system is minimized by pre-establishing a transaction gateway client having a static connection to the transaction processing system. In addition, the HTTP access to the transaction processing system is available for multiple concurrent users. The system further provides a gateway that is independent of the underlying service provided by the transaction processor, whereby the same gateway client is capable of usage with different databases and operations thereon.

U.S. Pat. No. 5,784,565

Inventor: Donald A. Lewine

Issued: Jul. 21, 1998

A method is disclosed for determining a user's identity and creating a virtual session using the HTTP protocol without modifying the protocol or changing its stateless nature.

U.S. Pat. No. 5,901,286

Inventor: Dan Danknick et al.

Issued: May 4, 1999

Process steps to provide communication between a web browser capable of initiating execution of a platform-independent segment of executable code and a peripheral having an HTTP server and an SNMP agent. A first packet is transferred to the HTTP server, and, in response, a file is transmitted to the web browser. The file contains a reference to a platform-independent segment of executable code. Upon processing the file, this code segment is requested from the HTTP server. After the web browser receives the executable code from the HTTP server, execution of the code segment is initiated in order to create an SNMP client. Execution of the code segment also causes a packet to be sent from the SNMP client to the SNMP agent in the peripheral. In response to this packet, information concerning the peripheral is transferred from the SNMP agent to the SNMP client.

U.S. Pat. No. 5,905,908

Inventor: Richard Hiers Wagner

Issued: May 18, 1999

An open network system for supporting input/output (I/O) operations for non-standard I/O devices are disclosed. The system includes a server coupled to a plurality of I/O devices through an open network and an extended open system protocol that supports communication with devices that are not personal computers (PCS). These devices include magnetic stripe readers, check readers, smart card readers, credit card terminals, screen phone terminals, PIN pads, printers, and the like. The extended open network protocol includes tags which identify device and input operations and attributes which identify the location, data exchange method, and data variable names for the retrieval, acquisition, and submission of data between the server and I/O devices. Preferably, the open network protocol is implemented in a Hyper Text Transport Protocol (HTTP). Preferably, the system includes a common gateway interface (CGI) at the server which converts protocol statements communicated between the server and I/O devices to application language statements for providing data to an application program coupled to the server. Most preferably, the application statements and protocol statements are constructed in integrated statements with an editor. The editor ensures that data identifiers in the application and protocol statements are compatible. The integrated statements are then parsed by the editor to segregate the protocol statements from the application statements. The protocol statements are downloaded in a file to a client program at an I/O device for processing. The application statements are stored in a file for use by the application. In this manner, generation of the files for client and application processing are automatically done without the user ensuring the correlation of the data fields in the two files.

U.S. Pat. No. 5,956,483

Inventor: Thomas A. Grate et al.

Issued: Sep. 21, 1999

A function calling protocol and methodology allow local function calls to be embedded within HTML documents, using standard HTML (HyperText Markup Language) tags, such that a user can selectively initiate the function calls while viewing the documents with a standard World Wide Web (“Web”) browser. User-invocable functions are thereby added to Web documents without modification to either existing Web browsers or HTML. In accordance with the invention, when a user initiates a local function call (by clicking on a button or other content item from within the Web browser), an HTTP (Hypertext Transfer Protocol) POST message which contains the information for making the function call is generated by the standard Web browser. This message is routed from the Web browser to an application (which runs on the same computer as the browser) using a conventional Local Host service of the computer's TCP/IP stack. The application then uses the function-calling information to make the function call on the computer. In an electronic shopping embodiment, the application is an electronic shopping client application which allows Web users to securely engage in commerce with on-line merchants over the Internet, and the Web documents of the system include functions for performing actions such as displaying the contents of a shopping basket object or a wallet object to the user.

U.S. Pat. No. 6,112,235

Inventor: Jason J. Spofford

Issued: Aug. 29, 2000

A method for remote management of a network hardware device using an industry standard internetwork protocol. A client and protocol stack are implemented on the computer network and an embedded server is installed on the network hardware device. Using the Hypertext Transfer Protocol (HTTP) and an available HTTP client, remote management of a hardware device is facilitated.

U.S. Pat. No. 6,128,653

Inventor: David del Val et al.

Issued: Oct. 3, 2000

A method for employing a Hypertext Transfer Protocol (HTTP protocol) for transmitting streamed digital media data from a server. The server is configured for coupling to a client computer via a computer network. The method includes receiving at the server from the client an HTTP POST request. The POST request requests a first portion of the digital media data and includes a request header and a request entity-body. The request entity body includes a media command for causing the first portion of the digital media data to be sent from the server to the client. The method further includes sending an HTTP response to the client from the server. The HTTP response includes a response header and a response entity body. The response entity body includes at least a portion of the first portion of the digital media data.

U.S. Pat. No. 6,138,150

Inventor: Stephen R. Nichols et al.

Issued: Oct. 24, 2000

A personal computer or workstation running a Web browser point and click interface is used to display and send information for remotely controlling a computer such as a mainframe. In the preferred embodiment, a web site or “home-page” is constructed on a secure HTTP (hyper text transfer protocol) server which comprises a Hardware Management Console (HMC). A user logs on to the Internet World Wide Web in a conventional manner by entering the address or uniform resource locator (URL) to connect to the secure HTTP server. Upon entry of a correct password the Hardware Management Console (HMC) home-page will be displayed. Icons representing various mainframe computer components are displayed which link to additional pages which the user can click on to monitor and control the mainframe computer. The color of the icons provide a summary of the status its representative component (e.g., a green icon indicates that the representative component is functioning is normally, red indicates an abnormal condition, and blue indicates that a message is available). Further, the user can change an automatic refresh rate for the browser stored at the server for a particular user identification (userid). Any action initiated by a remote web browser is reflected on the local Hardware Management Console (HMC) drag and drop interface and vice-versa.

U.S. Pat. No. 6,151,625

Inventor: Andrew G. Swales et al.

Issued: Nov. 21, 2000

A control system includes an Internet web interface to a network of at least one programmable logic control system running an application program for controlling output devices in response to status of input devices. The Web interface runs Web pages from an Ethernet board coupled directly to the PLC back plane and includes an HTTP protocol interpreter, a PLC back plane driver, a TCP/IP stack, and an Ethernet board kernel. The Web interface provides access to the PLC back plane by a user at a remote location through the Internet. The interface translates the industry standard Ethernet, TCP/IP and HTTP protocols used on the Internet into data recognizable to the PLC. Using this interface, the user can retrieve all pertinent data regarding the operation of the programmable logic controller system.

While these computer software programs designed for Internet interfacing may be suitable for the purposes for which they were designed, they would not be as suitable for the purposes of the present invention, as hereinafter described.

### SUMMARY OF THE PRESENT INVENTION

The present invention relates generally to communications software and, more specifically, to a hypertext transfer protocol application program interface (HTTP-API) method whereby a user of a first computer system can perform predetermined functions on a second computer system by exchanging commands using Hypertext Transfer Protocol (HTTP).

Most systems today provide a graphic interface in the form of webpages for remote users to access application functions. This method provides remote users with the ability to use the computer resources of a remote host computer to effect transaction processing and/or the transfer of information from one computer to another. These systems, while having the possibility of various operating systems, provide a general access communications port that uses the hypertext transfer protocol which defines a standardized method for systems to communicate with each other.

Web browsers, such as Netscape Navigator, Opera and Internet Explorer, are software programs designed to handle an array of text, video, and audio messages and there exists various software packages of programming protocols such as HTML, PHP, PERL, JAVA etc., that were designed to enhance the appearance of webpages.

While this method has proven itself invaluable in the creation and functioning of the Internet and enables almost anyone with a personal computer to communicate with any other Internet entity, it has also spawned a plethora of software products that can be required to perform the simplest tasks, such as filling out a form.

It is becoming incredibly time consuming downloading plug-ins and new versions of software while surfing the Internet. It is also becoming very difficult to engage a host site function with the continual redesign of websites wherein users are expected to drag and click there way through ever increasing host services.

Admittedly, since the basis of most Internet sites is to generate revenue there is a need for enhancement and change with the latest bells and whistles.

In the ever increasing electronic information age users are encouraged to conduct their business, from shopping to paying bills electronically. Companies are becoming, so called, mortarless institutions. New business is and will be generated by enticing surfers through webpage presentations to try their services. This entails presentations of text, audio and video which are easily accessible from the main page. Herein lies the problem for existing customers who have already been sold, are existing clients and wish to perform some predetermined function without having to view advertising and promotional material.

It is a primary objective of the present invention to provide a HTTP-API method and apparatus whereby an Internet client can communicate with an Internet server to perform a predetermined function without having the absolute need for a web browser, plugins or software languages contained within the server system.

This is accomplished by a software interface HTTP-API program that records in a first session the HTTP commands generated by the first Internet user and plays these commands back during subsequent secessions with the second Internet user. This could be as simple as signing on to the ABC Credit card company or the XYZ bank and retrieving current statements, or playing a command sequence that will sign onto a users account page within a brokerage firm. It is also possible to manipulate and reorder these commands.

To better understand the scope of the invention the following example is provides to illustrate the core element of the present invention.

For illustrative purposes a client-side user exists having a computer and subscribes to a stock trading system having a server-side webpage. The server-side stock trading system has the following four functions which are initiated by a user clicking on a server-side icon, Login, Account Balance, Portfolio List and Buy/Sell a stock.

The Login function requires the user to input name and password. The Account Balance function displays a screen with the user's cash balance. The portfolio List displays a table listing all stocks in the user's account and the Buy/Sell a stock function provides a method for the user to purchase and/or sell stocks, bonds, and futures.

The user has previously initiated all of the aforementioned functions and the client-side server-side exchange of HTTP comands and parameters having been recorded as discrete function can be incorporated into a software application that does not require the use of the client-side web browser or the server side web page.

For example, the ‘Login’ button requires the user to enter username password and click ‘OK’ to login. The user's machine might send the following HTTP transaction. POST “Login.asp?Username=Smith&Password=12345&Action=OK” Where the HTTP command is ‘Post’ and the parameters are:

Login.asp

Username=Smith

Password=12345

Action=OK

The server replies with the page that says “Login success” or “login failure”. The ‘Account Balance’ button sends the following HTTP transaction. Get “AccountBalance.asp”. Where the HTTP command is ‘Get’ and the parameter is: “Account Balance”. The server replies with a page listing clinrt account balance. The recording process is repeated for all desired buttons.

Once the HTTP transactions (HTTP commands and parameters) have been recordered, they can be played back in any order with different parameters. Such as logging on to the server site with any valid username password (Jones, 6789) simply by sending the login button HTTP transaction with different parameters: POST “Login.asp?Username=Jones&Password=6789&Action=OK”. TheJjones portfolio can be retrieved by sending the “Portfolio Button” HTTP command and parameters.

The use of precorded HTTP commands could be incorporated into various applications. Such as, a program for constantly monitoring the value of each stock in a portfolio list and selling any stock that shows a profit or loss of 10% without user intervention. This could be accomplished by first recording the HTTP commands and parameters as previously described. Then writing a program that would do the following by playing back the HTTP commands with the correct parameters:

1) Login User.

2) Retrieve the portfolio list showing profit/loss of each stock by sending the HTTP transaction to get the “Portfolio List”.

3) Analyize the portfolio list and determine which stocks show a profit or loss of 10%.

4) Sell the stocks that show a profit or loss of 10% by sending the HTTP commands and parameters (including stock symbol) to sell. Recorded from the BUY/Sell a stock button.

5) Continuously repeat 2 through 4 until user terminates the program. Any other user could reuse the program by simply changing the username and password parameter in step 1. The HTTP transactions were only recorded once.

A primary object of the present invention is to provide a computer software program for recording the Hypertext Transfer Protocol (HTTP) command instructions between a client and a server system.

Another object of the present invention is to provide a computer software program that can store the recorded HTTP instructions between a client and a server system.

Yet another object of the present invention is to provide a computer software program that can retrieve a stored recorded session of HTTP instructions between a client and server system.

Still yet another object of the present invention is to provide a computer software program that can transmit a stored recorded session of HTTP instructions between a client and server system.

Another object of the present invention is to provide a computer software program that can transmit a stored recorded session of HTTP instructions between a client and server system.

Yet another object of the present invention is to provide a computer program that can transmit a stored recorded session of HTTP instructions between a client and server system that will initiate a predetermined software application on a remote host system.

Still yet another object of the present invention is to provide a computer software program that can automate a communications protocol and initiate execution of a predetermined remote applications program.

Another object of the present invention is to provide means for a plurality of computers to communicate with a host computer without regard to variances in operating systems or web page design software, such as, HTML, PHP, JAVA, Flash, etc,.

Yet another object of the present invention is to provide telecommunication application programming interface that will capture HTTP commands and parameters between a first computer and a second computer.

Still yet another object of the present invention is to provide telecommunication application programming interface (API) that will capture HTTP commands and parameters between a first computer having a web browser and a second computer having a web page.

Another object of the present invention is to provide telecommunication application programming interface (API) that will capture HTTP commands and parameters exchanged between a first computer having a web browser accessing a function on a second computer having a web page.

Yet another object of the present invention is to provide telecommunication application programming interface (API) that will capture HTTP commands and parameters exchanged between a first computer having a web browser accessing a function on a second computer having a web page and store the HTTP commands and parameters as a retrievable entity.

Still yet another object of the present invention is to provide telecommunication application programming interface (API) that will capture all HTTP commands and parameters exchanged between a first computer having a web browser initiating a discrete function on a second computer's web page and storing the HTTP commands and parameters as a discrete retrievable entity within the first and/or second computers data storage media.

Another object of the present invention is to provide telecommunication application programming interface (API) that will store a plurality of uniquely identifiable retrievable discrete entities on a storage media comprising the HTTP commands and parameters associated with performing a function on a second computers web page.

Yet another object of the present invention is to provide telecommunication application programming interface (API) that will store a plurality of uniquely identifiable retrievable discrete entities on a storage media comprising the HTTP commands and parameters associated with performing a function on a second computers server.

Still yet another object of the present invention is to provide telecommunication application programming interface (API) that will store a plurality of uniquely identifiable retrievable discrete entities on a storage media comprising the HTTP commands and parameters associated with performing a function on a second computers server that can be used by a first computer to perform a uniquely identifiable function through a second computer's server.

Another object of the present invention is to provide telecommunication application programming interface (API) that will store a plurality of uniquely identifiable retrievable discrete entities on a storage media comprising the HTTP commands and parameters associated with performing a function on a second computers server without the need of a web browser or web page.

Yet another object of the present invention is to provide telecommunication application programming interface (API) comprised of prerecorded hypertext transfer protocol (HTTP) commands.

Still yet another object of the present invention is to provide HTTP-API for client-side and/or server side applications.

Another object of the present invention is to provide HTTP-API utilizing a common Messaging format for controlling the execution of client-side applications and/or server-side applications.

Additional objects of the present invention will appear as the description proceeds.

The present invention overcomes the shortcomings of the prior art by providing a software program for capturing HTTP commands between a client and a remote server application for the purpose of creating an executable recording of HTTP commands as an automated login to the aforementioned remote server application.

This method provides remote users with the ability to use the computer resources of a remote host computer to effect transaction processing and/or the transfer of information from one computer to another without having the absolute need for a web browser, plugins or software languages contained within the server system.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### LIST OF REFERENCE NUMERALS UTILIZED IN THE DRAWINGS

10 HTTP-API (hypertest transfer protocol application program interface)

12 client

14 web browser

16 HTML document

18 record HTTP commands

20 playlist HTTP commands

22 host server

24 web server

26 web server file system

30 prior art web page retrieval

32 client web browser

34 obtain URL

36 browser formats HTTP

38 TCP/IP process

40 web server retrieval

42 web server output

44 client objective web page

46 client recording of HTTP session

48 client plays recorded HTTP session

50 other HTTP commands

### BRIEF DESCRIPTION OF THE DRAWING FIGURES

In order that the invention may be more fully understood, it will now be described, by way of example, with reference to the accompanying drawing in which:

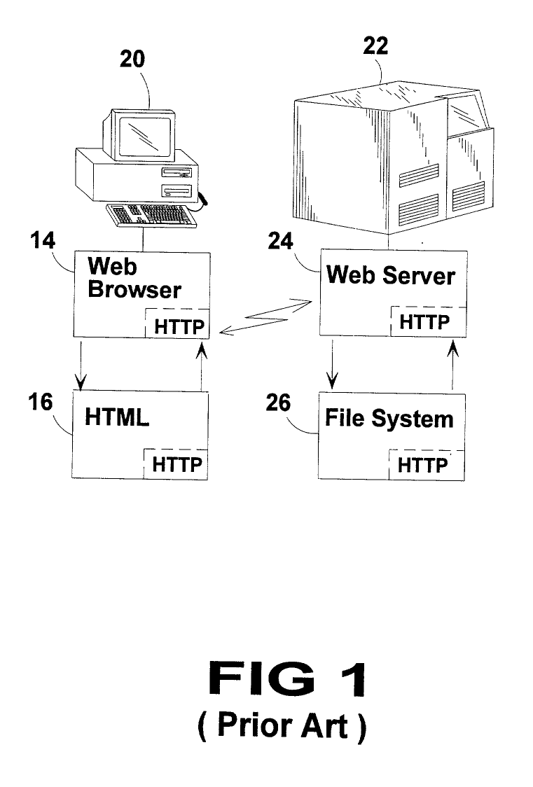

FIG. 1 is an illustrative view of the prior art showing communication between a web client and web server;

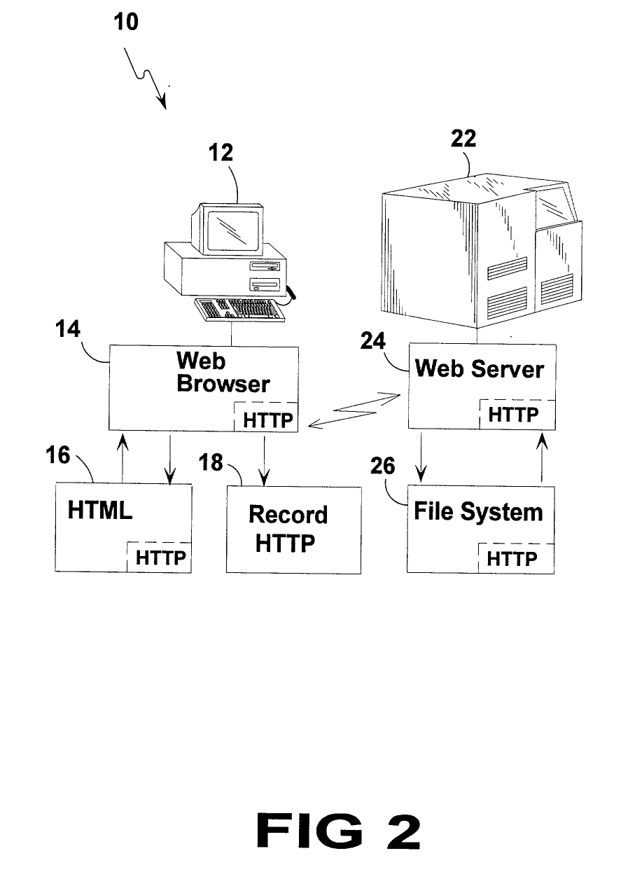

FIG. 2 is an illustrative view of the present invention showing the recording of the HTTP commands between a web client and web server;

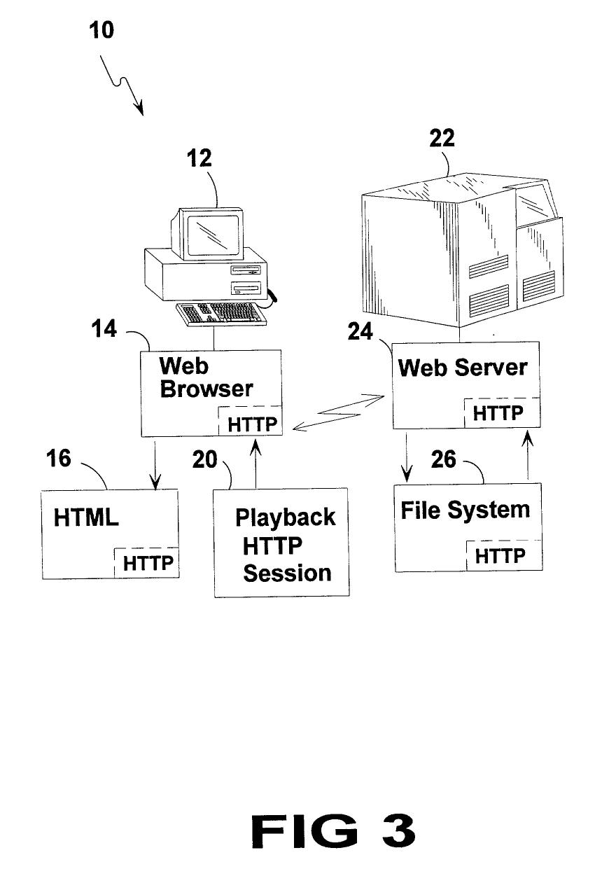

FIG. 3 is an illustrative view of the present invention showing a communication between a web client and web server using the HTTP-API.

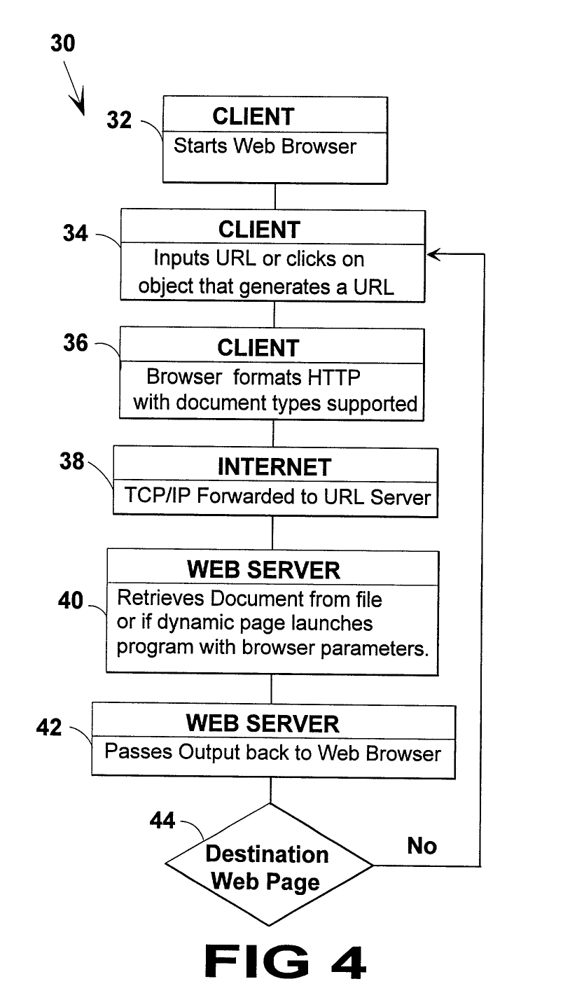

FIG. 4 is a flow chart of a typical exchange between a web client and web server.

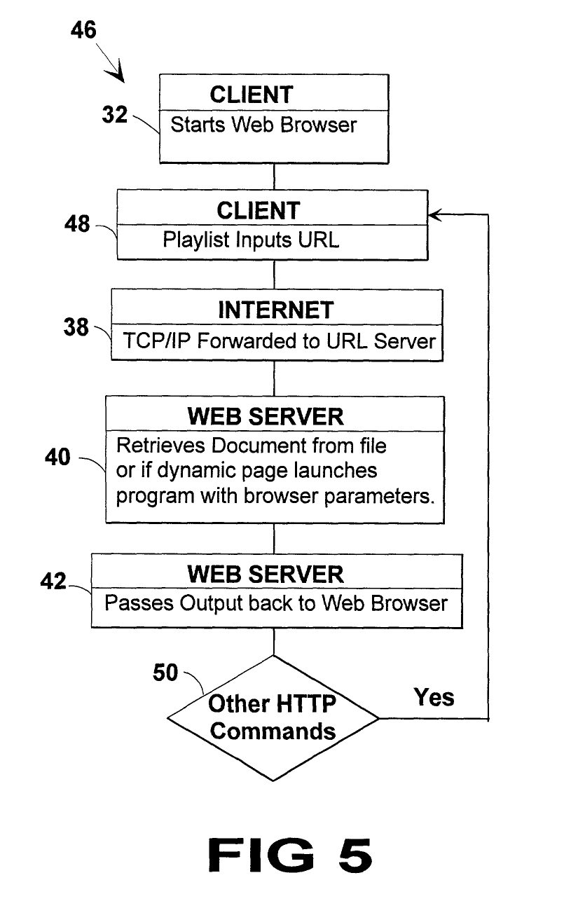

FIG. 5 is a flow chart of a communication exchange between a web client and web server using the HTTP-API.

### DETAILED DESCRIPTION OF THE PREFERRED EMBODIMENT

Turning now descriptively to the drawings in which similar reference characters denote similar elements throughout the drawing figures. FIG. 1 through FIG. 5 illustrate the Hypertext transfer Protocol Application program interface (HTTP-API) of the present invention indicated generally by the numeral 10.

Referring to FIG. 1 the client 12 invokes a web browser 14 that will control the exchange of information between the client 12 and web server 22. The client provides a host name URL that the web browser formats into an HTTP command that is sent through the Internet to the computer having the host name URL 22. The web server 22 returns the requested document from the file system 26 along with other information that will be used by the web browser 20 to display the page 16. The client 14 clicks on an object with the displayed page 16 wherein the web browser 14 contacts the web server 22 again for the requested information. This process continues until the client has retrieved all the requested information or an application process has been initiated;

Referring to FIG. 2 the client 12 invokes a web browser 14 that will control the exchange of information between the client 12 and web server 22. In addition the client-side HTTP-API program transcribes all of the client side session entries to a file. The client provides a host name URL that the web browser formats into an HTTP command that is sent through the Internet to the computer having the host name URL 22. The web server 22 returns the requested document from the file system 26 along with other descriptive addendum that will be used by the web browser 20 to display the web page 16. The client 14 clicks on an object within the displayed page 16 wherein the web browser 14 again contacts the web server 22 for the requested information. This process continues until the client has retrieved all the requested information or an application process has been initiated;

Referring to FIG. 3 the client 12 invokes a web browser 14 and the HTTP-API 20. The HTTP-API program 20 controls the exchange of information between the client 12 and web server 22. The HTTP-API program 20 invokes the web browser 14 using the previously recorded HTTP commands. The HTTP-API 20 provides a host name URL that the web browser forwards through the Internet to the computer having the host name URL 22. The web server 22 returns the requested document from the file system 26 along with other descriptive addendum that will be used by the web browser 20 to display the web page 16. The HTTP-API process will continue until the recorded session is complete;

Referring to FIG. 4, the client 12 invokes a web browser 32. The client provides a host name URL 34 that the web browser formats into an HTTP command 36 that is sent through the Internet to the computer having the host name URL 38. The web server 22 retrieves the requested document from the file system 40 along with other descriptive addendum that will be used by the web browser 20 to display the web page 16 and returns 42 the output to the web browser 20 . The client 14 continues to select information from the web server 22 until the destination process 44 has been completed;

Referring to FIG. 5, the client 12 invokes a web browser 32 and HTTP-API program. The HTTP-API provides a host name URL 48 that is sent through the Internet to the computer having the host name URL 38. The web server 22 retrieves the requested document from the file system 40 along with other descriptive addendum that will be used by the web browser 20 to display the web page 16 and returns 42 the output to the web browser 20. The HTTP-API 48 continues to generate HTTP commands until the recorded session has been played 50.

What is claimed is new and desired to be protected by Letters Patent is set forth in the appended claims:

1. A computer software program for capturing the HTTP commands generated by a user through a web browser to a remote web server, the program comprising:
a) means for capturing HTTP commands;
b) means for storing HTTP commands;
c) means for retrieving HTTP commands; and
d) means for transmitting HTTP commands.

2. The system of claim 1, wherein said means for capturing includes processing means for transcribing HTTP commands.

3. The system of claim 1, wherein said means for storing includes processing means for recording the HTTP commands to a storage media.

4. The system of claim 1, wherein said means for retrieving includes processing means for retrieving HTTP commands from a storage media.

5. The system of claim 1, wherein said means for transmitting includes processing for transmitting HTTP commands to the TCP/IP handler.

6. A computer software program for capturing the HTTP commands generated by a user through a web browser to a remote web server, the program comprising:
a) capturing HTTP commands;
b) storing HTTP commands;
c) retrieving HTTP commands; and
d) transmitting HTTP commands.

7. The system of claim 6, wherein said capturing HTTP commands includes processing for transcribing HTTP commands.

8. The system of claim 6, wherein said storing HTTP commands includes processing for recording the HTTP commands to a storage media.

9. The system of claim 6, wherein said means for retrieving HTTP commands includes processing for retrieving HTTP commands from a storage media.

10. The system of claim 6, wherein said means for transmitting HTTP commands includes processing for transmitting HTTP commands to the TCP/IP handler.

11. A HTTP-API method consisting of an interactive computer based program for recording HTTP commands between a client-side web browser and a web server.

12. The method of claim 11 further comprising processing means for storing the client-side web browser generated and web-server generated HTTP commands on a storage media.

13. The method of claim 12 further comprising processing means for retrieving an entity of HTTP session commands from a storage media.

14. The method of claim 13 further comprising processing means for executing an entity of HTTP session commands retrieved from a storage media.

15. A computer software program that can be selectively initiated by a user that will act as an interface between a client-side trading system and a server-side trading system.

16. The computer software program of claim 15, having modified prerecorded HTTP commands for executing functions on a server-side trading system.

17. The computer software program of claim 15, having computer programming code for querying the user of said software for parameter information for completing the embedded HTTP commands.

18. The computer software program of claim 15, having computer programming code for modifying the output of a client-side trading system.

19. The computer software program of claim 15, having computer programming code for querying a user as to selected modifications to be made to the client-side trading system output data.

20. The computer software program of claim 15, having computer programming code for interfacing with a server-side trading system.
